(19) United States
(12) Patent Application Publication
(10) Pub. No.: US 2016/0215630 A1
(43) Pub. Date: Jul. 28, 2016

(54) COATING, COATED TURBINE COMPONENT, AND COATING PROCESS

(71) Applicant: General Electric Company, Schenectady, NY (US)

(72) Inventors: Kalaga Murali KRISHNA, Bangalore, Karnataka (IN); Padmaja PARAKALA, Bangalore, Karnataka (IN); Surinder Singh PABLA, Greer, SC (US)

(21) Appl. No.: 13/941,673

(22) Filed: Jul. 15, 2013

(51) Int. Cl. F01D 5/28; C09D 5/08; C08K 3/34; C08K 3/30; C09D 5/10; C08K 3/26; C09D 163/00; C09D 7/12

(52) U.S. Cl. CPC F01D 5/288; C09D 163/00; C09D 5/08; C09D 7/1216; C08K 3/30; C09D 5/106; C08K 3/26; C08K 3/346; C08K 3/34; C08K 2003/265; C08K 2003/3045

(57) ABSTRACT

A coating, a coated turbine component, and a coating process are disclosed. The coating includes an epoxy-polyamide structure formed from a coating composition comprising a phenolic resin and a curing agent, the phenolic resin comprising a bisphenol F constituent and an epichlorohydrin constituent. The coating composition is solvent-free or substantially solvent-free. The cured coating is cross-linked from curing below 120° C., from curing using infrared-microwave radiation, or a combination thereof. The coated turbine component includes a surface and the coating. The coating process includes applying the coating and curing the coating.

### FIELD OF THE INVENTION

The present invention is directed to coatings, coated components, and processes of coating components. More particularly, the present invention is directed to substantially solvent-free and solvent-free coatings.

### BACKGROUND OF THE INVENTION

Gas turbines are continuously being exposed to harsher conditions including higher temperature and pressure, in order to improve efficiency. The higher temperatures and pressures may have deleterious effects on gas turbine components, such as creep damage, fatigue and cracking. This damage can require repair or replacement of the component, which is both costly and time consuming.

Repair and replacement of components often result in significant operational delays, lost production, and reduced overall operational efficiency. When a component, such as a turbine blade, is damaged, the turbine can be shut down and the blade is removed for repair. In addition to the time required to remove a damaged blade and re-install a repaired blade, the entire turbine can be in operation during repair.

Past attempts for such repair have included use of chemical additives during a water wash cycle to periodically clean the blades to regain compressor efficiency. However, such processes are not very effective, for example, due to inferior chemistries or practical operational constraints, such as increased and/or repetitive maintenance cycle frequencies.

A coating, a coated turbine component, and a coating process that do not suffer from one or more of the above drawbacks would be desirable in the art.

### BRIEF DESCRIPTION OF THE INVENTION

In an embodiment, a cured coating includes an epoxy-polyamide structure formed from a coating composition comprising a phenolic resin and a curing agent, the phenolic resin comprising a bisphenol F constituent and an epichlorohydrin constituent. The cured coating is cross-linked from curing below 120° C., from curing using infrared-microwave radiation, or a combination thereof. The coating composition is solvent-free or substantially solvent-free.

In another embodiment, a coated turbine component includes a substrate and a cured coating positioned on the substrate. The cured coating includes an epoxy-polyamide structure formed from a coating composition comprising a phenolic resin and a curing agent, the resin comprising a bisphenol F constituent and an epichlorohydrin constituent, wherein the cured coating is cross-linked from curing below 120° C., from curing using infrared-microwave radiation, or a combination thereof. The coating composition includes, by weight, between about 40% and about 45% being the phenolic resin, between about 8% and about 9% being the curing agent, between about 5% and about 10% being an anticorrosive agent, between about 10% and about 15% being a thixotropic agent, between about 15% and about 20% being an extender material, between about 1% and about 2% being an erosion-resistant filler, or a combination thereof. The extender material is selected from the group consisting of barium sulphate, calcium sulphate, talc, calcium carbonate, and combinations thereof. The anticorrosive agent is selected from the group consisting of zinc dust, zinc phosphate, iron sulphide, borate, precipitated silica, TiO₂, iron oxide, ZrO₂ and combinations thereof. The erosion-resistant filler material is selected from the group consisting of alumina, silica, boron carbine, silicon carbide, titania, and combinations thereof.

In another embodiment, the coating process includes applying a coating composition, the coating composition comprising a phenolic resin and a curing agent, the resin comprising a bisphenol F constituent and an epichlorohydrin constituent, and curing the coating composition through thermal curing below 120° C., through infrared-microwave radiation, or a combination thereof. The coating composition is solvent-free or substantially solvent-free.

Other features and advantages of the present invention will be apparent from the following more detailed description of the preferred embodiment, which illustrates, by way of example, the principles of the invention.

### DETAILED DESCRIPTION OF THE INVENTION

Disclosed is a coating, a coated turbine component, and a coating process. Embodiments of the present disclosure, for example, in comparison to coatings that do not include one or more of the features disclosed herein, permit upgrade to high-performance coating efficiency across existing fleets, permit easy to implement changes to airfoil surfaces, permit reduction of costs, permit repair in non-manufacturing settings, permit increased abrasion-resistance, permit increased flexibility, or a combination thereof.

The coating is a cured coating having an epoxy-polyamide structure. The epoxy-polyamide structure is formed from a coating composition including a phenolic resin, a curing agent, and, in some embodiments, other suitable additives. In one embodiment, the coating composition further includes an anticorrosive agent, a thixotropic agent, an extender material, an erosion-resistant filler, or a combination thereof. In further embodiments, a viscosity modifier is added to the coating composition.

The phenolic resin includes a bisphenol F constituent and an epichlorohydrin constituent that react with the curing agent to form the epoxy-polyamide structure. The curing agent facilitates the reaction through cross-linking from curing below 120° C. (for example, from about 20° C. to about 120° C., from 80° C. to about 120° C., at about 80° C., at about 100° C., at about 120° C., or any suitable combination, sub-combination, range, or sub-range therein). Additionally or alternatively, the curing agent facilitates the reaction through cross-linking from infrared-microwave radiation.

The curing to form the cured coating is by thermal curing and/or from radiation having a longer wavelength than visible light, such as, infrared radiation and microwave radiation. The cured coating is a single layer or a plurality of layers, including intermediate layers. In one embodiment, the curing is sequential, for example, with intermediate heating for about 15 to about 30 minutes at a plurality incremental temperature levels, at least two incremental levels of the plurality of the incremental temperature levels being different by at least 15° C. to increase durability and adhesion. In one embodiment, the curing is sequential and a first layer of the plurality of the intermediate layers and a second layer of the plurality of the intermediate layers are cross-linked through an initial partial curing of the first layer and a subsequent curing of the first layer concurrent with an at least partial curing of the second layer.

The cured coating includes any suitable physical characteristics capable of being achieved with the process disclosed herein. Suitable thicknesses of the cured coating are between about 50 micrometers and about 200 micrometers, between about 50 micrometers and about 100 micrometers, between about 50 micrometers and about 70 micrometers, between about 50 micrometers and about 60 micrometers, between about 100 micrometers and about 200 micrometers, between about 150 micrometers and about 200 micrometers, or any suitable combination, sub-combination, range, or sub-range therein. Suitable discrete porosities of the cured coating are, by volume, less than about 1 percent. Suitable roughness values of the cured coating are between about 5 Ra and about 10 Ra, between about 5 Ra and about 7 Ra, between about 7 Ra and about 10 Ra, or any suitable combination, sub-combination, range, or sub-range therein.

The coating composition includes any suitable amount of the phenolic resin. In one embodiment, the coating composition includes, by weight, between about 40% and about 45% being the phenolic resin, between about 40% and about 43% being the phenolic resin, between about 42% and about 45% being the phenolic resin, or any suitable combination, sub-combination, range, or sub-range therein.

The coating composition includes any suitable curing agent at any suitable amount. In one embodiment, the coating composition includes, by weight, between about 8% and about 9% being the curing agent, about 8% being the curing agent, about 9% being the curing agent, or any suitable combination, sub-combination, range, or sub-range therein. Suitable curing agents include, but are not limited to, polyamide, an aromatic amine, polyamidoamine, butyl titanate, phenalkamine, and combinations thereof.

In one embodiment, the coating composition includes any suitable anticorrosive agent at any suitable amount to impart high temperature stability with corrosion resistance, to reduce porosity thereby inhibiting corrosion, to increase resistance to fouling and chemical attack, and/or to provide other desired properties. In one embodiment, the coating composition includes, by weight, between about 5% and about 10% being the anticorrosive agent, between about 7% and about 10% being the anticorrosive agent, between about 5% and about 8% being the anticorrosive agent, or any suitable combination, sub-combination, range, or sub-range therein. Suitable anticorrosive agents include, but are not limited to, zinc dust, zinc phosphate, iron sulphide, borate, precipitated silica, TiO₂, iron oxide, ZrO₂, and combinations thereof.

In one embodiment, the coating composition includes any suitable thixotropic agent at any suitable amount to provide desired viscosity and flow-control features, such as, to prevent sagging after the coating is applied onto the surface. In one embodiment, the coating composition includes, by weight, between about 10% and about 15% being the thixotropic agent, between about 10% and about 13% being the thixotropic agent, between about 12% and about 15% being the thixotropic agent, or any suitable combination, sub-combination, range, or sub-range therein. Suitable thixotropic agents include, but are not limited to, 2-1 clay, mica, silicon fumes, and combinations thereof. In one embodiment, the thixotropic agent allows the coating composition to be applied to surfaces that are not perpendicular to gravity, such as angled surfaces, curved surfaces, vertical surfaces, or combinations thereof. For example, in one embodiment, the coating composition is applied to one or more surfaces of a turbine component (while installed or in a manufacturing facility). The turbine component is an airfoil, a compressor blade or bucket, a dovetail, a nozzle, a rotor, a stator, a turbine wheel, any other suitable component, or a combination thereof.

In one embodiment, the coating composition includes any suitable extender material at any suitable amount. In one embodiment, the coating composition includes, by weight, between about 15% and about 20% being the extender material, between about 15% and about 18% being the extender material, between about 17% and about 20% being the extender material, or any suitable combination, sub-combination, range, or sub-range therein. Suitable extender materials include, but are not limited to, barium sulphate, calcium sulphate, talc, calcium carbonate, and combinations thereof.

In one embodiment, the coating composition includes any suitable erosion-resistant filler material at any suitable amount. In one embodiment, the coating composition includes, by weight, between about 1% and about 2% being the erosion-resistant filler, about 1% being the erosion-resistant filler, about 2% being the erosion-resistant filler, or any suitable combination, sub-combination, range, or sub-range therein. Suitable erosion-resistant materials include, but are not limited to, alumina, silica, boron carbine, silicon carbide, titania, and combinations thereof.

The coating composition includes or excludes any other suitable materials to achieve desired properties. For example, in one embodiment, the coating composition includes crack resistance, for example, by including glass flakes and/or milled glass fiber. In one embodiment, the coating composition is solvent-free or substantially solvent-free (for example, having less than 0.5% solvent, by volume), to meet government standards regarding volatile organic compounds and/or to be environmentally friendly. As used herein, the term volatile organic compound refers to material having a vapor pressure of 0.01 kPa or more at 20° C.

In one embodiment, the viscosity modifier, such as, ethanol and/or butanol, is added to the coating composition to achieve a suitable viscosity. A suitable viscosity is between about 100 centipoises (0.1 Pascal-second) and about 150 centipoises (0.15 Pascal-second) and a suitable concentration of the viscosity modifier is at about 8%. Additionally or alternatively, the viscosity modifier is adjusted for the specific application technique, for example, dip-application, spray application, vacuum-coating application, curtain-coating application, brush-application, or roll-coat application.

The coating composition is applied and cured to form the cured coating through any suitable process, as determined by the component to be coated and the environment in which the coating is to occur. For example, coating in a manufacturing facility versus coating on-site where a component is installed (or in a non-manufacturing setting proximal to where the component is installed or repaired) includes different features.

In one embodiment, the process of coating on-site, while the component is installed, and/or in the non-manufacturing setting includes selectively applying the coating composition without prior mixing of one or more of the constituents of the coating composition. For example, in one embodiment, the one or more constituents remaining separate until application include the phenolic resin, the curing agent, the anticorrosive agent, the thixotropic agent, the viscosity modifier, the extender material, the erosion-resistant filler, or a combination thereof. In a further embodiment, the concentration of one or more of the constituents is adjusted during the mixing based upon component-specific information, such as, an amount of surface to be coated, a depth of the coating to be applied, or a combination thereof.

The surface coated is any suitable surface. In one embodiment, the surface is a rusted surface. Prior to applying the coating composition, in one embodiment, the surface to be coated is prepared and/or treated, for example, to increase adhesion of the coating.

In one embodiment, the cured coating includes corrosion resistance, for example, to a solution, by volume, of about 90% Naptha and about 10% aqueous brine. The corrosion resistance over a period of up to about 60 hours, at a temperature of about 130° C., a pressure of about 2.2 bars of N₂, and a pH of about 1.7, in an autoclave having rotation of about 1500 revolutions per minute has corrosion resistance of less than about 2 mils of the cured coating being corroded over a year. In further embodiments, the annual of amount cured coating corroded is less than about 1.71 mils, less than about 1.6 mils, less than about 1.5 mils, and/or less than about 0.4 mils.

In one embodiment, the cured coating includes foulant resistance, for example, to a foulant having soot and oil, a pH of about 11, while applied at a temperature of about 80° C. and a pressure of about 3 bars of N₂, then heated to a temperature of about 100° C. for about 24-hours, followed by a water wash for about 1 minute.

In one embodiment, the cured coating includes resistance to penetration of humidity. In this embodiment, substantially no gas or vapor molecules permeate through the cured coating, even at higher temperatures, such as above 120° C., above 150° C., above 180° C., up to 200° C., or any suitable combination, sub-combination, range, or sub-range therein.

In one embodiment, the cured coating includes hydrophobic and/or oleophobic characteristics, as shown by contact angle measurements.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A cured coating, comprising:
an epoxy-polyamide structure formed from a coating composition comprising a phenolic resin and a curing agent, the phenolic resin comprising a bisphenol F constituent and an epichlorohydrin constituent;
wherein the cured coating is cross-linked from curing below 120° C., from curing using infrared-microwave radiation, or a combination thereof;
wherein the coating composition is solvent-free or substantially solvent-free.

2. The cured coating of claim 1, wherein the cured coating has a thickness between about 50 micrometers and about 200 micrometers.

3. The cured coating of claim 1, wherein the cured coating has a discrete porosity of less than about 3 percent, by volume.

4. The cured coating of claim 1, wherein the coating has a surface roughness of between about 5 Ra and about 10 Ra.

5. The cured coating of claim 1, wherein the cured coating is hydrophobic and oleophobic.

6. The cured coating of claim 1, wherein the composition includes, by weight, between about 40% and about 45% being the phenolic resin, between about 8% and about 9% being the curing agent, between about 5% and about 10% being an anticorrosive agent, between about 10% and about 15% being a thixotropic agent, between about 15% and about 20% being an extender material, between about 1% and about 2% being an erosion-resistant filler, or a combination thereof.

7. The cured coating of claim 1, wherein the coating composition further comprises a thixotropic agent selected from the group consisting of 2-1 clay, mica, silicon fumes, and combinations thereof.

8. The cured coating of claim 1, wherein the coating composition further comprises an extender material selected from the group consisting of barium sulphate, calcium sulphate, talc, calcium carbonate, and combinations thereof.

9. The cured coating of claim 1, wherein the coating composition further comprises an anticorrosive agent selected from the group consisting of zinc dust, zinc phosphate, iron sulphide, borate, precipitated silica, TiO₂, iron oxide, ZrO₂, and combinations thereof.

10. The cured coating of claim 1, wherein the coating composition further comprises an erosion-resistant filler material selected from the group consisting of alumina, silica, boron carbine, silicon carbide, titania, and combinations thereof.

11. The cured coating of claim 1, further comprising crack-resistant materials selected from the group consisting of glass flakes, milled glass fiber, and combinations thereof.

12. The cured coating of claim 1, wherein the cured coating is positioned on a rusted surface.

13. The cured coating of claim 1, wherein the cured coating is positioned on a treated substrate, the treated substrate being primed with zinc phosphate, blast-cleaned, sand-blasted, hydro-jetted, or a combination thereof.

14. The cured coating of claim 1, wherein the curing agent is selected from the group consisting of polyamide, an aromatic amine, polyamidoamine, butyl titanate, phenalkamine, and combinations thereof.

15. The cured coating of claim 1, wherein the cured coating includes physical features from being roll-coat-applied, spray-coat-applied, or dip-coat-applied.

16. The cured coating of claim 1, wherein the cured coating includes physical features from intermediate heating for 15 to 30 minutes at a plurality incremental temperature level, at least two incremental levels of the plurality of the incremental temperature levels being different by at least 15° C.

17. The cured coating of claim 1, wherein the cured coating is positioned on a turbine component, the turbine component being selected from the group consisting of an airfoil, a compressor blade, and combinations thereof.

18. The cured coating of claim 1, wherein the cured coating includes a plurality of intermediate layers, a first layer of the plurality of the intermediate layers and a second layer of the plurality of the intermediate layers being cross-linked through an initial partial curing of the first layer and a subsequent curing of the first layer concurrent with an at least partial curing of the second layer.

19. A coated turbine component, comprising:
a substrate; and
a cured coating positioned on the substrate, the cured coating comprising an epoxy-polyamide structure formed from a coating composition comprising a phenolic resin and a curing agent, the resin comprising a bisphenol F constituent and an epichlorohydrin constituent, wherein the cured coating is cross-linked from curing below 120° C., from curing using infrared-microwave radiation, or a combination thereof;
wherein the composition includes, by weight, between about 40% and about 45% being the phenolic resin, between about 8% and about 9% being the curing agent, between about 5% and about 10% being an anticorrosive agent, between about 10% and about 15% being a thixotropic agent, between about 15% and about 20% being an extender material, between about 1% and about 2% being an erosion-resistant filler, or a combination thereof;
wherein the extender material is selected from the group consisting of barium sulphate, calcium sulphate, talc, calcium carbonate, and combinations thereof;
wherein the anticorrosive agent is selected from the group consisting of zinc dust, zinc phosphate, iron sulphide, borate, precipitated silica, TiO₂, iron oxide, ZrO₂, and combinations thereof; and
wherein the erosion-resistant filler material is selected from the group consisting of alumina, silica, boron carbine, silicon carbide, titania, and combinations thereof.

20. A coating process, comprising:
applying a coating composition, the coating composition comprising a phenolic resin and a curing agent, the resin comprising a bisphenol F constituent and an epichlorohydrin constituent; and
curing the coating composition through thermal curing below 120° C., through infrared-microwave radiation, or a combination thereof;
wherein the coating composition is solvent-free or substantially solvent-free.
